(19) United States
(12) Patent Application Publication
(10) Pub. No.: US 2002/0175198 A1
(43) Pub. Date: Nov. 28, 2002

(54) Device for infeeding a web

(76) Inventor: Andreas Josef Kleinschnitz, Leinach (DE)

Correspondence Address: Douglas R Hanscom, Jones Tullar & Cooper, P O Box 2266 Eads Station, Arlington, VA, 22202, US

(21) Appl. No.: 10/111,402

(22) PCT Filed: Jan. 22, 2001
(86) PCT No.: PCT/DE01/00248

(30) Foreign Application Priority Data
Feb. 2, 2000 (DE) 100 04 482.4

(51) Int. Cl. G03B 1/56

(52) U.S. Cl. 226/91; 226/19

(57) ABSTRACT

The invention relates to a device for axially adjusting guides for paper web infeed means of rotary printing machines. According to the invention, different alignments of the paper infeed means can be set, said alignments being distanced from the lateral mount.

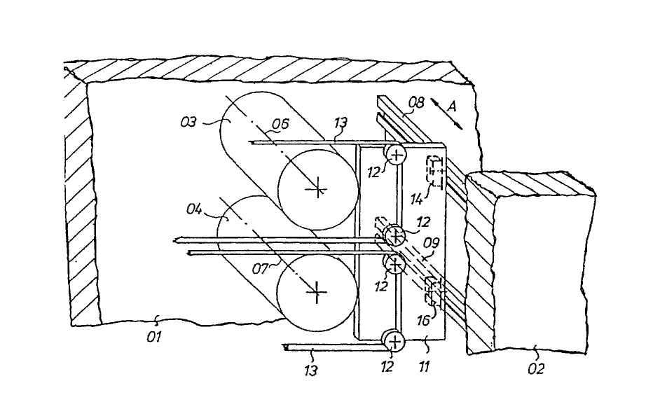

The invention relates to a device for drawing in a web in accordance with the preamble of claim 1.

It is generally known to fasten guide devices for paper web draw-in means, for example for cables, belts or roller chains at least to the inside of one of the lateral frames of a web-fed rotary printing press. For example, in DE-OS 22 41 127 the guide devices are fastened to the inside of the lateral frame by means of forked supports.

The object of the invention is based on providing a device for drawing in a web.

The object is attained in accordance with the invention by means of the characteristics of claim 1.

The advantages which can be achieved by means of the invention lie in particular in creating a guidance for paper web draw-in means which can be adapted to the width of the roll changer. In the course of this, holders can be adjusted in such a way that the alignment of the paper web draw-in means is in agreement with the paper web width.

An exemplary embodiment of the invention is represented in the drawings and will be described in greater detail in what follows.

The drawings show a perspective representation of a device in accordance with the invention for the axial adjustment of guide devices for paper web draw-in means.

Rollers 03, 04, for example paper guide rollers, are rotatably seated between lateral frames 01, 02 of a web-fed rotary printing press. Spaced-apart guide rails 08, 09, which point in the axis-parallel direction A of the axes of rotation 06, 07, are fastened on at least one lateral frame 02. The guide rails 08, 09 can, for example, consist of C-shaped profiled sections and, as represented in the drawings, can also be embodied traverse-like between both lateral frames 01, 02.

Slidable crossheads, not represented, provided with threaded bores are for example arranged in the C-shaped profiled sections.

A holder 11, which can be displaced infinitely variably in the axis-parallel direction A is arranged in the guide rollers 08, 09, and supports one or several guide devices 12, for example guide rollers, for receiving or diverting a paper web draw-in means 13, for example a belt system which can be pulled forward and back.

The holder 11 can consist of a plate, for example, which has brackets 14, 16 pointing in the axis-parallel direction A, through which the plate-shaped holder 11 is in connection by means of holding screws, not represented, with the slidable crossheads of the guide rail 08, 09. In this way the paper draw-in means 13 are arranged slidable in the axis-parallel direction A in respect to a lateral edge of a paper web, not represented, which is to be drawn in.

The draw-in means 13 is arranged in a first position in the vicinity of a lateral edge of a first web of a first width, and the draw-in means in a second position in the vicinity of a lateral edge of a second web of a second width.

Each of the holders 11 can receive the guide devices 12 for one or several paper draw-in means 13.

The guide devices 12 can also consist of curved C-shaped hollow profiled sections for receiving finite paper draw-in means 13, for example a roller chain.

The start of a paper web is fastened in a known manner on the paper web draw-in device.

List of Reference Numerals

01 Lateral frame
02 Lateral frame
03 Roller
04 Roller
05 —
06 Axis of rotation (03)
07 Axis of rotation (03)
08 Guide rail
09 Guide rail
10 —
11 Holder
12 Guide device (13)
13 Paper web draw-in means
14 Bracket (11)
15 —
16 Bracket (11)
A Direction, axis parallel

1. A device for drawing-in a web, wherein a draw-in means (13) is movably arranged in several guide devices (12), characterized in that several guide devices (12) for diverting the draw-in means (13) are arranged on a common holder (11), and that the holder (11) is arranged transversely in respect to the conveying direction of the web so that it can change its position.

2. The device in accordance with claim 1, characterized in that the draw-in device (13) is embodied as a belt or cable.

3. The device in accordance with claim 1, characterized in that the draw-in device (13) is embodied as a chain.

4. The device in accordance with claim 1, characterized in that the guide device (12) is embodied as a roller (12).

5. The device in accordance with claim 1, characterized in that the guide device has a C-shaped cross section.

6. A device for drawing-in a web, wherein a draw-in means (13) is movably arranged in at least one guide device (12), characterized in that the guide device (12) for diverting the draw-in means (13) is arranged transversely in respect to the conveying direction of the web so that it can change its position, that in a first position the draw-in means (13) is arranged in the vicinity of a lateral edge of a first web of a first width, and that in a second position the draw-in means (13) is arranged in the vicinity of a lateral edge of a second web of a second width.

7. The device in accordance with claim 1, characterized in that the device is arranged in a rotary printing press.
